(19) United States
(12) Patent Application Publication
(10) Pub. No.: US 2010/0060755 A1
(43) Pub. Date: Mar. 11, 2010

(54) IMAGE FORMING METHOD AND APPARATUS FOR USING BLACK-AND WHITE CAMERA TO CAPTURE COLOR IMAGE

(76) Inventor: Jin-Feng Wang, GuangDong (CN)

Correspondence Address: SINORICA, LLC, 2275 Research Blvd., Suite 500, ROCKVILLE, MD, 20850, US

(21) Appl. No.: 12/441,534

(22) PCT Filed: Oct. 9, 2006
(86) PCT No.: PCT/CN06/02633

§ 371 Date: Mar. 17, 2009

(30) Foreign Application Priority Data
Sep. 20, 2006 (CN) 200610122261.6

(51) Int. Cl. H04N 9/04

(52) U.S. Cl. 348/280; 348/E09.002

(57) ABSTRACT

An image forming method and apparatus for using black-white camera to capture color image, in case that range of saturation regulating factor is given as 0.5-3, and range of illuminance gain is given as 0.5-3, and under the following conditions, the functions of a red LED light ring-shaped light source assembly, a green LED light ring-shaped light source assembly, and a blue LED light ring-shaped light source assembly, can be realized through using a light source luminous intensity regulating circuit, thus being able to regulate their illuminance respectively in achieving regulation of white balance: in an environment not being affected by outside lights or outside lights influence can be neglected, and an object being taken images is stationary relate to said black-white camera in a round of image taking process of a synthesized color image; when taking images, the open and close of each of respective assemblies of light sources can be realized through a light source luminous sequence control circuit; and when all light sources are ready, a camera actuation image taking process can be realized through a control circuit. As such, through the application of the present invention, an image forming method and apparatus for using said black-white camera to capture color image can be provided, that has the advantages of low cost, producing color of an image close to that of a real image, high sensitivity to light, and fulfilling the requirements of top-notch applications without having to use filters.

### BACKGROUND OF THE INVENTION

1. Field of the Invention

The present invention relates to an image forming system, and in particular to an image forming method and apparatus for using black-white camera to capture color image.

2. The Prior Arts

In general, image formation of ordinary color camera achieves its color imaging function by making use of Bayer Filter Patterns together with a filter. Wherein, pixel value of a pixel and those of adjacent pixels are utilized to perform color interpolation algorithm in obtaining R, G, B values of the respective pixels. However, the disadvantage of adopting this method is that, the photo-electrons of adjacent pixels of a color camera are liable to overflow, thus incurring color distortion, low color saturation. In addition, in this method, since filters must be utilized, thus the sensitivity and flexibility of color camera to light are rather insufficient.

Presently, a kind of 3 CCD camera may be used to overcome this problem and shortcoming, yet the production cost of 3CCD camera is rather high, and it is not liable to be promoted and widely utilized.

In addition, there exists solution in taking color image by utilizing black-white camera: irradiating an observed object by emitting red, green, and blue three mono-color lights in rotation, and each time obtaining color information of an observed object separately, and then processing this color information into color image through software processing. Yet in quite a lot of top-notch applications, there are increasing emphases on short duration light exposure and large and deep field. However, the shortcoming of utilizing this image formation method is that: firstly, the time taken to obtain a color image is three times as that required by an ordinary color camera previously; secondly, white balance solution is not realized, however, in order to achieve excellent color image effect, it is not possible to obtain better image than that as acquired by an ordinary color camera without implementing white balance. In addition, in an ordinary camera, saturation adjustment and gain adjustment functions are provided, and that are indispensable in some of the applications, such as in an application of utilizing color information in realizing object altitude variations, the saturation of image produced must be enhanced. Therefore, the solution of synthesizing color images with mono-color light utilized presently is not mature enough, and thus it is not very useful and effective in some of the applications, as such it still has much room for improvements.

### SUMMARY OF THE INVENTION

Due to the problems and drawbacks of the prior art, a major objective of the present invention is to provide an image forming method and apparatus for using black-white camera to capture color image, which has the advantages of low cost, producing color of an image close to that of a real image, high sensitivity to light, and fulfilling the requirements of top-notch applications without having to use filters.

In order to solve the above-mentioned problems and shortcomings of the prior art, the image forming method and apparatus for using black-white camera to capture color image according to the present invention includes the following steps:
(1) utilizing a red LED light, a green LED light, and a blue LED light as source of light, for emitting and irradiating directly on imaging object with composite lights of any two colors as chosen from red light, green light, and blue light in a rotation manner;
(2) forming images of an object on a light sensing chip of a camera through an optical lens, processing by peripheral circuits of the images received by the light sensing chip of the camera into digital image information and transmitting it to a processor (PC), thus obtaining at the same position on processor (PC) the following images in an environment of composite lights of three colors: red plus green gray level image 11, green plus blue gray level image 12, and blue plus red gray level image 13;
(3) for a gray level value i1 of a position corresponding to red plus green gray level image 11, a gray level value i2 of a position corresponding to green plus blue gray level image 12, and a gray level value i3 of a position corresponding to blue plus red gray level image 13, performing the following calculation processes for the respective points on the image by means of an image synthesis & calculation processing module, in obtaining red component value r, green component value g, and blue component value b of the present position through the following formulas, thus obtaining a color image having its saturation and illuminance fulfilling the requirements,
the formulas mentioned above are as follows:
i1=r+g
i2=g+b
i3=b+r
a1=(i1+i2+i3)/2
a2=s*(i1−i2)
a3=s*(i1−I3)
r=gain*(a1+2*a2−a3)/3
b=gain*(r−a2)
g=gain*(a3+b)
wherein, s is a saturation regulating factor, with its range 0.5-3;
   gain is an illuminance gain, with its range 0.5-3; and
   a1, a2, and a3 are assumed parameters;
(4) upon setting saturation gain and illuminance gain, proceeding with white balance of color imaging; firstly, taking color image of standard gray level color card, then calculating the average illuminance of red component value r, green component value g and blue component value b of an entire color image, and finally regulating illuminance of light source through a light source emission intensity regulation circuit, so that the red component value r, green component value g, and blue component value b are essentially the same, then determining regulation and locking onto the light source emission intensity regulation circuit, hereby finishing white balance of color imaging; and
(5) when taking images of a real object again, thus being able to obtain high definition color image having its color close to that of a real image, performing iteration in synthesizing color images for realizing a real time display effect.

In the present invention, an image forming apparatus for using black-white camera to capture color image includes: a black-white camera, a red LED light ring-shaped light source assembly, a green LED light ring-shaped light source assembly, and a blue LED light ring-shaped light source assembly, a light source emission intensity regulation circuit, a light source luminous sequence control circuit, an actuation camera image taking circuit, a light source power supply module, a standard gray level color card, and an image synthesis & calculation process module. In the structure mentioned above, the red LED light ring-shaped light source assembly, the green LED light ring-shaped light source assembly, and the blue LED light ring-shaped light source assembly are distributed on a surface of a semi-hemisphere of a black-white camera facing downward, as such on top is the red LED light ring-shaped light source assembly, in the middle is the green LED light ring-shaped light source assembly, and at bottom is the blue LED light ring-shaped light source assembly, hereby forming an imaging environment having uniform illuminance in a field of vision of a black-white camera. Furthermore, the outputs of the light source emission intensity regulation circuit and the light source luminous sequence control circuit are used to control the light source power supply module; the output of the light source power supply module is used to control the red LED light ring-shaped light source assembly, the green LED light ring-shaped light source assembly, and the blue LED light ring-shaped light source assembly; and the light source power supply module is used to record data onto the image synthesis & calculation process module. Moreover, the outputs of the light source emission intensity regulation circuit, the light source luminous sequence control circuit, and the image synthesis & calculation process module are used to control the actuation camera image taking circuit, and the output of the actuation camera image taking circuit is connected into a photo sensing chip of the camera.

For a preferred embodiment of the present invention, the image forming method and apparatus for using black-white camera to capture color image of the present invention can be utilized in an automatic optical detector system.

The benefits and advantages of the present invention as compared with the prior art are as follows:

1. The resolution of image produced in the present invention is three times that as produced by Bayer Filter Pattern color camera;

2. In the present invention, the problem of photoelectron overflow of adjacent pixels occurred in Bayer Filter Pattern color camera does not exist;

3. In the present invention, the problem of color distortion incurred by interpolation calculation is eliminated;

4. The sensitivity to light of the image forming apparatus of the present invention is raised significantly in that in the present invention, composite color light illumination is utilized, and due to light overlapping and complementation, so that sensitivity of a camera can be raised to twice that as compared with image forming using mono-color light; meanwhile, since in the present invention, usually, a black-white camera need not use a filter, thus it can achieve the same speed in taking a color image as can be done by an ordinary color camera, hereby solving the problem of speed too low of the prior art in taking color images utilizing black-white camera;

5. In the present invention, the illuminance of each set of light sources can be adjusted separately, and white balance is performed for the synthesized image through utilizing standard gray level color card, hereby solving the problem that color temperature of image formed is abnormal and can not be adjusted as happen in the prior art, in taking color images utilizing a black-white camera;

6. In an image synthesis process of the present invention, saturation regulating factor and gain regulation factor are introduced, so as to fulfill the requirements of certain specific applications, hereby improving the insufficiency of realization of coloring functions of black-white camera; and

7. In the present invention, the cost of a black-white camera is only ⅙ that of a 3CCD camera, while achieving much better performances; while the cost of black-white camera of the present invention is lower than that of ordinary color camera. Therefore, the present invention provides an image forming method and apparatus for using black-white camera to capture color image, that has the advantages of low cost, producing color of an image close to that of a real image, high sensitivity to light, and fulfilling the requirements of top-notch applications without having to use filters.

### BRIEF DESCRIPTION OF THE DRAWINGS

The related drawings in connection with the detailed description of the present invention to be made later are described briefly as follows, in which:

FIG. 1 is a schematic diagram of an image forming apparatus for using black-white camera to capture color image according to an embodiment of the present invention;

FIG. 2 is a schematic diagram of an image forming apparatus for using black-white camera in performing white balance according to an embodiment of the present invention; and

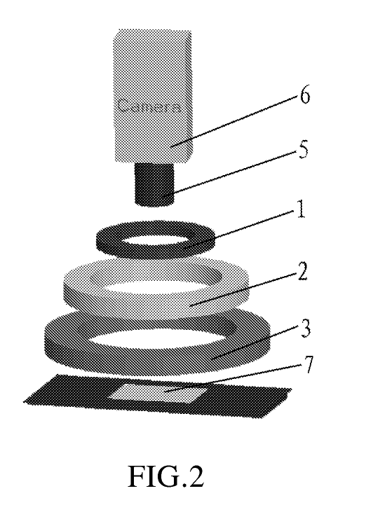

FIG. 3 is a circuit diagram of an image forming apparatus for using black-white camera to capture color image according to an embodiment of the present invention.

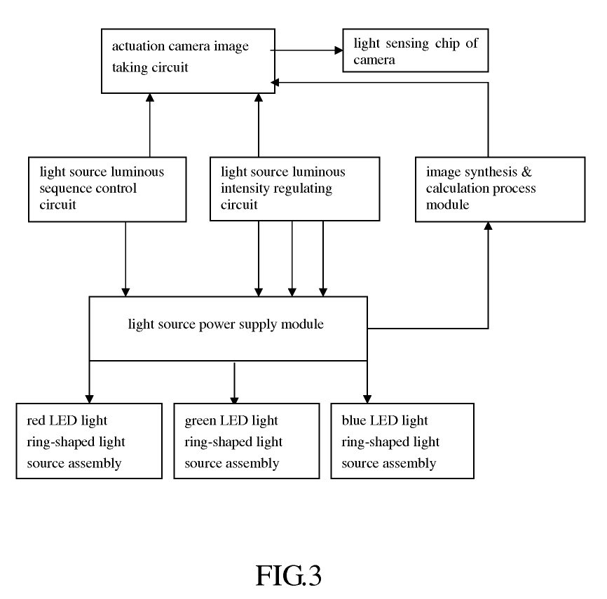

### DETAILED DESCRIPTION OF THE PREFERRED EMBODIMENT

The purpose, construction, features, functions and advantages of the present invention can be appreciated and understood more thoroughly through the following detailed descriptions with reference to the attached drawings.

In the following, a detailed description of the present invention is given through real embodiments together with the attached drawings.

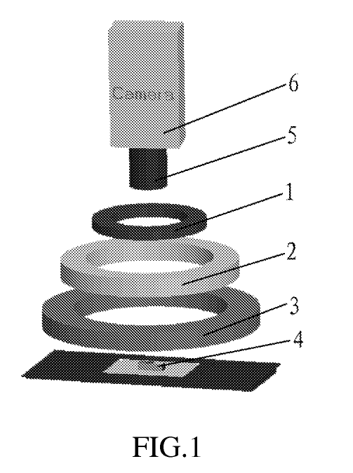

Firstly, referring to FIG. 1 for a schematic diagram of an image forming apparatus for using black-white camera to capture color image according to an embodiment of the present invention. As shown in FIG. 1, an image forming apparatus for using black-white camera to capture color image includes: a black-white camera, a red LED light ring-shaped light source assembly 1, a green LED light ring-shaped light source assembly 2, and a blue LED light ring-shaped light source assembly 3, a light source emission intensity regulation circuit, a light source luminous sequence control circuit, an actuation camera image taking circuit, a light source power supply module, a standard gray level color card 7, and an image synthesis & calculation process module. In the structure mentioned above, the red LED light ring-shaped light source assembly 1, the green LED light ring-shaped light source assembly 2, and the blue LED light ring-shaped light source assembly 3 are distributed on a surface of a semi-hemisphere of a black-white camera facing downward, as such on top is the red LED light ring-shaped light source assembly 1, in the middle is the green LED light ring-shaped light source assembly 2, and at bottom is the blue LED light ring-shaped light source assembly 3, hereby forming an imaging environment having uniform illuminance in a field of vision of a black-white camera. Furthermore, the outputs of the light source luminous intensity regulating circuit and the light source luminous sequence control circuit are used to control the light source power supply module; the output of the light source power supply module is used to control the red LED light ring-shaped light source assembly 1, the green LED light ring-shaped light source assembly 2, and the blue LED light ring-shaped light source assembly 3; and the light source power supply module is used to record data onto the image synthesis & calculation process module. Moreover, the outputs of the light source luminous intensity regulating circuit, the light source luminous sequence control circuit, and the image synthesis & calculation process module are used to control the actuation camera image taking circuit, and the output of the actuation camera image taking circuit is connected into a photo sensing chip of the camera.

Subsequently, an image forming method for using black-white camera to capture color image according to an embodiment of the present invention are described in details as follows, including the following steps:
(1) utilizing red LED light ring-shaped light source assembly 1, green LED light ring-shaped light source assembly 2, and blue LED light as source of light ring-shaped light source assembly 3 as sources of light, for emitting and irradiating directly on imaging object 4 with composite lights of any two colors as chosen from red light, green light, and blue light (composite light of red plus green, or composite light of green plus blue, or composite light of blue plus red) in a rotation manner;
(2) forming images of an object 4 on a light sensing chip 6 of a camera through an optical lens 5, processing by peripheral circuits of the images received by the light sensing chip 6 of a camera into digital image information and transmitting it to a processor (PC), thus obtaining at the same position on processor (PC) the following images in an environment of composite lights of three colors: red plus green gray level image 11, green plus blue gray level image 12, and blue plus red gray level image 13;
(3) for a gray level value i1 of a position corresponding to red plus green gray level image 11, a gray level value i2 of a position corresponding to green plus blue gray level image 12, and a gray level value i3 of a position corresponding to blue plus red gray level image 13, performing the following calculation processes for the respective points on the image by means of an image synthesis & calculation processing module, in obtaining a red component value r, a green component value g, and a blue component value b of the present position through the following formulas, thus obtaining a color image having its saturation and illuminance fulfilling the requirements,
the formulas mentioned above are as follows:
i1=r+g
i2=g+b
i332 b+r
a1=(i1+i2+i3)/2
a2=s*(i1−i2)
a3=s*(i1−I3)
r=gain*(a1+2*a2−a3)/3
b=gain*(r−a2)
g=gain*(a3+b)
wherein, s is a saturation regulating factor, with its range 0.5-3;
   gain is an illuminance gain, with its range 0.5-3, such as gain=1.3; and
   a1, a2, and a3 are assumed parameters;
(4) upon setting saturation gain and illuminance gain, proceeding with white balance of color imaging; firstly, taking color image of standard gray level color card 7, then calculating an average illuminance of red component value r, green component value g and blue component value b of an entire color image, and finally regulating illuminance of light source through a light source luminous intensity regulating circuit, so that the red component value r, green component value g, and blue component value b are essentially the same, then terminating regulation and locking onto the light source luminous intensity regulating circuit, hereby finishing white balance of color imaging;
in case that s=1.6, gain=1.3, then the average value of the collected color image red component value r is 150, the average value of the collected color image green component value g is 150, and the average value of the collected color image blue component value b is 150; and
(5) when taking images of a real object again, thus being able to obtain high definition color image having its color close to that of a real image, performing iteration in synthesizing color images for realizing real-time display effect.
For a preferred embodiment of the present invention, the image forming method and apparatus for using black-white camera to capture color image of the present invention can be utilized in an automatic optical detector system, so as to obtain image quality of 3CCD color camera and having similar overall performances.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. An image forming method for using black-white camera to capture color image, comprising the following steps:
(1) utilizing a red LED light, a green LED light, and a blue LED light as source of light, for emitting and irradiating directly on imaging object (4) with composite lights of any two colors as chosen from red light, green light, and blue light in a rotation manner;
(2) forming images of an object (4) on a light sensing chip (6) of a camera through an optical lens (5), processing by peripheral circuits of the images received by the light sensing chip (6) of a camera into digital image information and transmitting it to a processor (PC), thus obtaining at the same position on said processor (PC) the following images in an environment of composite lights of three colors: red plus green gray level image (11), green plus blue gray level image (12), and blue plus red gray level image (13);
(3) for a gray level value (i1) of a position corresponding to said red plus green gray level image (11), a gray level value (i2) of a position corresponding to said green plus blue gray level image (12), and a gray level value (i3) of a position corresponding to said blue plus red gray level image (13), performing the following calculation processes for the respective points on an image by means of an image synthesis & calculation processing module, in obtaining red component value (r), green component value (g), and blue component value (b) of the present position through the following formulas, thus obtaining a color image having its saturation and illuminance fulfilling the requirements,
the formulas mentioned above are as follows:
i1=r+g
i2=g+b
i3=b+r
a1=(i1+i2+i3)/2
a2=s*(i1−i2)
a3=s*(i1−I3)
r=gain*(a1+2*a2−a3)/3
b=gain*(r−a2)
g=gain*(a3+b)
wherein, said s is a saturation regulating factor, with its range 0.5-3;
said gain is an illuminance gain, with its range 0.5-3; and
said a1, a2, and a3 are assumed parameters;
(4) upon setting saturation gain and illuminance gain, proceeding with white balance of color imaging; firstly, taking color image of standard gray level color card (7), then calculating an average illuminance of said red component value (r), said green component value (g) and said blue component value (b) of an entire color image, and finally regulating illuminance of light source through a light source luminous intensity regulating circuit, so that said red component value (r), said green component value (g), and said blue component value (b) are essentially the same, then terminating regulation and locking onto the light source luminous intensity regulating circuit, hereby finishing white balance of color imaging; and
(5) when taking images of a real object again, thus being able to obtain high definition image having its color close to that of a real image, performing iteration in synthesizing color images for realizing real-time display effect.

2. An image forming apparatus for using black-white camera to capture color image, comprising:
a black-white camera, a red LED light ring-shaped light source assembly (1), a green LED light ring-shaped light source assembly (2), and a blue LED light ring-shaped light source assembly (3), further comprising:
a light source luminous intensity regulating circuit, a light source luminous sequence control circuit, an actuation camera image taking circuit, a light source power supply module, a standard gray level color card (7), and an image synthesis & calculation process module,
wherein
said red LED light ring-shaped light source assembly (1), said green LED light ring-shaped light source assembly (2), and said blue LED light ring-shaped light source assembly (3) are distributed on a surface of a semi-hemisphere of said black-white camera facing downward, as such on top is said red LED light ring-shaped light source assembly (1), in middle is said green LED light ring-shaped light source assembly (2), and at bottom is said blue LED light ring-shaped light source assembly (3), hereby forming an imaging environment having uniform illuminance in a field of vision of said black-white camera,
outputs of said light source luminous intensity regulating circuit and said light source luminous sequence control circuit are used to control said light source power supply module; said output of said light source power supply module is used to control said red LED light ring-shaped light source assembly (1), said green LED light ring-shaped light source assembly (2), and said blue LED light ring-shaped light source assembly (3); and said light source power supply module is used to record data onto said image synthesis & calculation process module,
said outputs of said light source luminous intensity regulating circuit, said light source luminous sequence control circuit, and said image synthesis & calculation process module are used to control said actuation camera image taking circuit, and
said output of said actuation camera image taking circuit is connected into a photo sensing chip of said camera.

3. The image forming apparatus for using black-white camera to capture color image as claimed in claim 2, wherein
said image forming apparatus for using black-white camera in capturing color images can be applied in an automatic optical detector system.
